(19) United States
(12) Patent Application Publication
(10) Pub. No.: US 2009/0188613 A1
(43) Pub. Date: Jul. 30, 2009

(54) METHOD AND APPARATUS FOR APPLYING PRESSURE SENSITIVE ADHESIVE LABELS TO CONTAINERS

(75) Inventor: Richard A. Fearn, Cincinnati, OH (US)

Correspondence Address: THOMPSON HINE L.L.P.;Intellectual Property Group, P.O. BOX 8801, DAYTON, OH, 45401-8801, US

(73) Assignee: Spear USA, LLC, Mason, OH (US)

(21) Appl. No.: 12/020,737

(22) Filed: Jan. 28, 2008

(51) Int. Cl. B65C 3/00; B65C 9/18

(52) U.S. Cl. 156/249; 156/538

(57) ABSTRACT

A labeling apparatus for continuously labeling containers with printed labels from a continuous roll of backing material includes a continuous release liner web of backing material in roll form. The continuous release liner web of backing material has a plurality of labels adhered thereon at spaced-apart label regions using a pressure sensitive adhesive. The continuous release liner web of backing material is configured to allow the labels to be removed therefrom without damaging the labels. A feeding mechanism is configured to continuously dispense the continuous release liner web of backing material with the labels adhered thereon. A peel plate includes a peeling edge over which the continuous release liner web of backing material is drawn by the feeding mechanism. The edge of the peel plate has a shape that promotes a leading edge of the labels to loosen from the continuous release liner web of backing material as the corresponding label region is drawn over the peeling edge. A vacuum roller includes channels extending inwardly from a periphery of the vacuum roller. The channels are in communication with a vacuum source. The vacuum roller is arranged and configured (i) to engage a label at its leading edge prior to a leading edge of the label being loosened from the continuous release liner web of backing material by being drawn over the peeling edge of the peel plate and (ii) to capture the label and direct the label from the continuous release liner web of backing material to a periphery of a container as the vacuum roller rotates by overcoming the bond between the pressure sensitive adhesive and the continuous release liner web of backing material through use of a negative pressure applied to the label through at least some of the channels in communication with the vacuum source.

### TECHNICAL FIELD

The present application relates to a method and apparatus for applying pressure sensitive adhesive labels to containers.

### BACKGROUND

Printed labels are widely used on containers to identify the particular products, manufacturers, and brand names associated with the products in those containers. Conventional labels for containers include label facestocks made from paper, films, and other polymeric materials. Paper-based labels typically have an opaque appearance, whereby the contents of the container are at least partially concealed from view. While paper-based labels are generally inexpensive, they are susceptible to damage, such as by abrasion or scuffing and generally exhibit poor adhesion in wet or humid environments. Opaque labels have also been made from polymeric materials, including thin films. While these materials offer improved resistance to scuffing and abrasion, as well as improved adhesion in humid conditions, opaque polymeric labels also conceal at least a portion of the product held within the container.

A recent trend in labeling containers has been towards utilizing clear thin film labels which provide a “label-less” or “printed-on” look. These labels have the advantages of improved resistance to scuffing and abrasion, and good adhesion in moist environments, and further provide improved aesthetic appearance of the containers to which they are applied. Both paper-based and polymeric labels are commonly imprinted with various graphics and text which may be applied to the labels by various methods including gravure printing, lithography, flexography, screen printing, and other methods suitable for creating the desired indicia on the labels.

Container labels described above have typically been provided in “cut-and-stack” form or roll form for application to containers by automated labeling equipment. In the cut-and-stack form, a plurality of individual labels are provided in a stack to a labeling machine, generally in a magazine, whereby the machine is configured to apply individual labels from the stack to containers as they are moved past a labeling station.

Labels may also be provided in roll form wherein a plurality of discrete labels are provided on an elongate web of backing material that has been wound into a roll. The web of backing material is directed past a peel tip at a labeling station to transfer the label from the backing material to the individual product containers. This method of supplying labels to containers has typically been utilized with thin film and other polymeric labels. Adhesive is generally pre-applied to the labels and may be pressure sensitive or heat activated to adhere to the containers.

### SUMMARY

In an aspect, a labeling apparatus for continuously labeling containers with printed labels from a continuous roll of backing material includes a continuous release liner web of backing material in roll form. The continuous release liner web of backing material has a plurality of labels adhered thereon at spaced-apart label regions using a pressure sensitive adhesive. The continuous release liner web of backing material is configured to allow the labels to be removed therefrom without damaging the labels. A feeding mechanism is configured to continuously dispense the continuous release liner web of backing material with the labels adhered thereon. A peel plate includes a peeling edge over which the continuous release liner web of backing material is drawn by the feeding mechanism. The edge of the peel plate has a shape that promotes a leading edge of the labels to loosen from the continuous release liner web of backing material as the corresponding label region is drawn over the peeling edge. A vacuum roller includes channels extending inwardly from a periphery of the vacuum roller. The channels are in communication with a vacuum source. The vacuum roller is arranged and configured (i) to engage a label at its leading edge prior to a leading edge of the label being loosened from the continuous release liner web of backing material by being drawn over the peeling edge of the peel plate and (ii) to capture the label and direct the label from the continuous release liner web of backing material to a periphery of a container as the vacuum roller rotates by overcoming the bond between the pressure sensitive adhesive and the continuous release liner web of backing material through use of a negative pressure applied to the label through at least some of the channels in communication with the vacuum source.

In another aspect, a method of applying a pressure sensitive adhesive label to a container using a labeling apparatus is provided. The method includes providing a continuous release liner web of backing material in roll form. The continuous release liner web of backing material has a plurality of labels adhered thereon at spaced-apart label regions using a pressure sensitive adhesive. The continuous release liner web of backing material is configured to allow the labels to be removed therefrom without damaging the labels. The continuous release liner web of backing material with the labels adhered thereon is continuously fed using a feeding mechanism. The continuous release liner web of backing material is drawn over a peel plate including a peeling edge over which the continuous release liner web of backing material is drawn by the feeding mechanism. The edge of the peel plate has a shape that promotes a leading edge of the labels to loosen from the continuous release liner web of backing material as the corresponding label region is drawn over the peeling edge. A label is engaged at its leading edge with a vacuum roller prior to the leading edge of the label being loosened from the continuous release liner web of backing material by the label region being drawn over the peeling edge of the peel plate. The label is released from the continuous release liner web of backing material as the vacuum roller rotates by overcoming the bond between the pressure sensitive adhesive and the continuous release liner web of backing material through use of a negative pressure applied to the label through channels of the vacuum roller in communication with a vacuum source.

In another aspect, a labeling apparatus for continuously labeling containers with printed labels from a continuous roll of backing material includes a feeding mechanism configured to continuously dispense a continuous release liner web of backing material with labels adhered thereon at spaced-apart label regions using a pressure sensitive adhesive. The continuous release liner web of backing material configured to allow the labels to be removed therefrom without damaging the labels. A peel plate including a peeling edge over which the continuous release liner web of backing material is drawn by the feeding mechanism. The peeling edge of the peel plate having a shape that promotes a leading edge of the labels to loosen from the continuous release liner web of backing material as the corresponding label region is drawn over the peeling edge. A vacuum roller includes channels extending inwardly from a periphery of the vacuum roller. The channels are in communication with a vacuum source. The vacuum roller is arranged and configured (i) to engage a label at its leading edge prior to a leading edge of the label being loosened from the continuous release liner web of backing material by being drawn over the peeling edge of the peel plate and (ii) to capture the label and direct the label from the continuous release liner web of backing material to a periphery of a container as the vacuum roller rotates by overcoming the bond between the pressure sensitive adhesive and the continuous release liner web of backing material through use of a negative pressure applied to the label through at least some of the channels in communication with the vacuum source.

Other advantages and features of the invention will be apparent from the following description of particular embodiments and from the claims.

### BRIEF DESCRIPTION OF DRAWINGS

FIG. 1 is a diagrammatic plan view of an embodiment of a labeling apparatus; and

FIG. 2 is a diagrammatic section view detailing an embodiment of a vacuum roller for use with the labeling apparatus of FIG. 1.

### DESCRIPTION

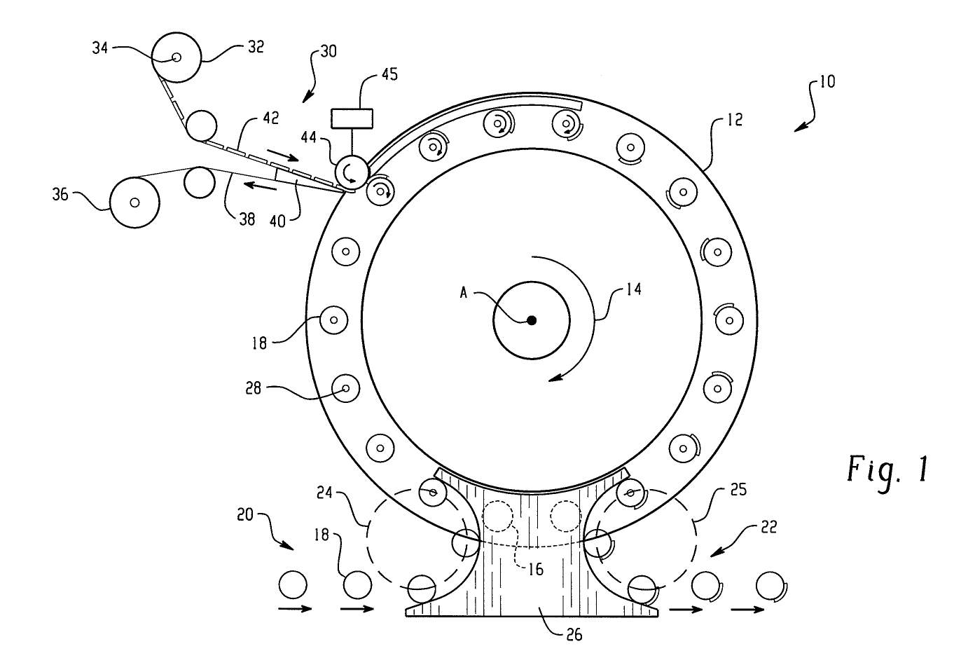

Referring to FIG. 1, a pressure sensitive adhesive labeling apparatus 10 includes a turntable 12 that rotates about a central axis A in the direction of arrow 14. The turntable 12 carries support plates 16 located about the central axis A and spaced radially therefrom. The support plates 16 are sized to carry containers 18 thereon and perform a rotational sequence as the turntable rotates.

The labeling apparatus 10 includes a container infeed 20 at which containers 18 are fed onto the support plates 16 and a container outfeed 22 at which containers are fed from the labeling apparatus once they have been labeled. An infeed conveyor 24 is used to carry the containers 18 to their associated support plate 16 and an outfeed conveyor 25 is used to carry the containers from their respective support plate. A guide member 26 is used to guide the containers along their infeed and outfeed paths. A top hold down fixture (represented by element 28) may be used to stabilize the containers 18 on their support plates 16.

Downstream from the container infeed 20 is a label applicator system 30. The label applicator system 30 includes a continuous roll 32 of pressure sensitive adhesive labels 42, a roll support 34 and a take-up roller 36 that takes up a release liner web 38 once the pressure sensitive labels have been removed therefrom. The release liner web 38 is drawn around a peeling plate 40 that promotes removal of the pressure sensitive labels 42 from the release liner web. A vacuum roller 44 is located adjacent the peeling plate 40 and is in communication with a vacuum source 45. As will be described in greater detail below, the vacuum roller 44 (a) engages the pressure sensitive adhesive labels 42 at their leading edges just prior to their being loosened from the release liner web 38 by the release liner web being drawn over the peel plate, (b) captures and directs the pressure sensitive adhesive labels from the release liner web to the container as the vacuum roller rotates by overcoming the bond between the pressure sensitive adhesive and the release liner and (c) applies the pressure sensitive adhesive labels to the containers 18.

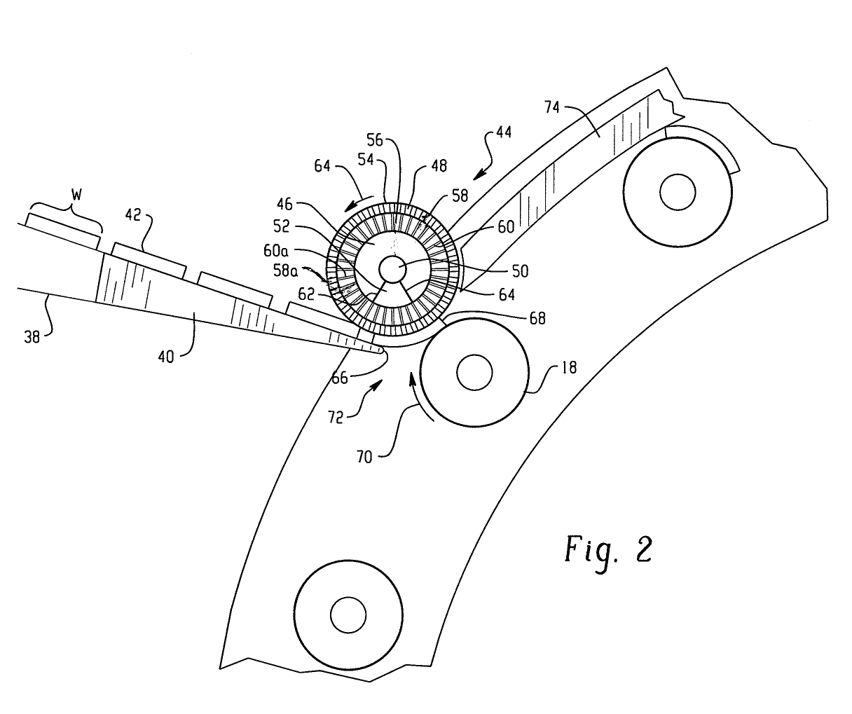

Referring to FIG. 2, the vacuum roller 44 (shown diagrammatically in section view) includes an inner portion 46 and an outer portion 48 that rotates relative to the inner portion. In some embodiments, the inner portion is stationary. The inner portion 46 includes an opening 50 extending therethrough that is in communication with the vacuum source 45 (FIG. 1) such that negative pressure can be drawn within the opening 50. The opening 50 is in communication with a vacuum cavity 52, which, in this embodiment, is wedge shaped, increasing in width toward the periphery of the inner portion 46.

The outer portion 48 includes an outermost member 54 and an innermost member 56 that is concentric with the outermost member and disposed about the periphery of the inner portion 46. The outermost member 54 includes a plurality of outer vacuum channels 58 that are aligned with inner vacuum channels 60 of the innermost member 56. In one embodiment, the outermost member 54 is a sleeve that is placed about the innermost member 56 such that the channels 58 and 60 are aligned. As another example, the outermost member 54 may be a coating. In some embodiments, the outermost member 54 is formed of a material different from the innermost member 56. For example, the outermost member 54 may be formed of a relatively elastic, deflectable material such as a plastic or rubber material, while the innermost member 56 is formed of a relatively hard material such as metal, wood or hard plastic.

The vacuum cavity 52 is sized and shaped such that only a portion of the aligned vacuum channels 58, 60 are in communication with the vacuum source at any given time. As the outer portion 48 rotates relative to the inner portion 46 in the direction of arrow 64, the aligned vacuum channels 58a and 60a approach edge 62 of the wedge-shaped vacuum cavity 52. When the aligned channels 58a and 60a move past the edge 62, negative pressure is drawn within the aligned vacuum channels 58a and 60a. Negative pressure continues to be drawn within the aligned vacuum channels 58a and 60a until the aligned channels move past edge 64 of the wedge-shaped vacuum cavity 52. Thus, each aligned vacuum cavity is in communication with the vacuum source for only a portion of its travel about the periphery of the inner portion 46. The number and size of the vacuum channels and amount of negative vacuum pressure can be selected to overcome the bond between the label and the release liner web 38 in order to release the label from the release liner web without distorting the label during application. Additionally, while the vacuum roller 44 is illustrated in section, the vacuum channels extend over the length of the vacuum roller.

As shown by FIG. 2, the aligned channels 58 and 60 may move past the edge 62 and come into communication with the vacuum source at a location upstream from an end 66 of the peeling plate 40. The aligned channels 58 and 60 may then move past edge 64 and out of communication with the vacuum source at a location downstream from the end 66 of the peeling plate 40. This allows the vacuum roller 44 to engage a pressure sensitive adhesive label 42 near its leading edge 68 due to the negative pressure at a location upstream of the end 66 of the peeling plate 40, then release the pressure sensitive adhesive label near its leading edge at a location downstream of the end of the peeling plate.

In some embodiments, the outer portion 48 of the vacuum roller 44 rotates slightly slower than the container 18 rotates in the direction of arrow 70. This can allow for taught application of the pressure sensitive adhesive labels 42 to the containers 18. As the release liner web 38 is drawn over the end 66 of the peeling plate 40, the vacuum roller 44 captures the pressure sensitive adhesive label 42 and directs the label, beginning with the leading edge 68, from the release liner to a periphery of the container 18. A gap 72 between the container 18 and vacuum roller 44 is such that pressure is applied to the pressure sensitive label 42 by the outermost member 54 as the label is applied to the container. As noted above, the outermost member 54 can be formed of a relatively elastic, deflectable material, which deflects due to application of pressure to the pressure sensitive adhesive label 42. Once the leading edge 68 of the pressure sensitive adhesive label 42 is adhered to the container 18, it is released as the associated aligned channels 46 and 48 move past the edge 64 of the vacuum cavity 52. Thus, the vacuum roller 44 is used to apply pressure to the pressure sensitive adhesive labels 42 along substantially the entirety of their widths W as they are applied to the containers 18. The containers 18 along with their associated labels 42 may be rotated past a wiping plate 74, which may also be used to apply pressure against the labels as the containers 18 continue to be rotated.

It is to be clearly understood that the above description is intended by way of illustration and example only and is not intended to be taken by way of limitation, and that changes and modifications are possible. In one embodiment, the diameter of the vacuum roller 44 is only slightly larger (e.g., 10 percent larger or less) than the diameter of the container 18. Accordingly, other embodiments are contemplated and modifications and changes could be made without departing from the scope of this application as expressed by any claims now included or hereafter added.

What is claimed is:

1. A labeling apparatus for continuously labeling containers with printed labels from a continuous roll of backing material, the labeling apparatus comprising:
a continuous release liner web of backing material in roll form, the continuous release liner web of backing material having a plurality of labels adhered thereon at spaced-apart label regions using a pressure sensitive adhesive, the continuous release liner web of backing material configured to allow the labels to be removed therefrom without damaging the labels;
a feeding mechanism configured to continuously dispense the continuous release liner web of backing material with the labels adhered thereon;
a peel plate including a peeling edge over which the continuous release liner web of backing material is drawn by the feeding mechanism, the peeling edge of the peel plate having a shape that promotes a leading edge of the labels to loosen from the continuous release liner web of backing material as the corresponding label region is drawn over the peeling edge; and
a vacuum roller including channels extending inwardly from a periphery of the vacuum roller, the channels being in communication with a vacuum source, the vacuum roller being arranged and configured (i) to engage a label at its leading edge prior to a leading edge of the label being loosened from the continuous release liner web of backing material by being drawn over the peeling edge of the peel plate and (ii) to capture the label and direct the label from the continuous release liner web of backing material to a periphery of a container as the vacuum roller rotates by overcoming the bond between the pressure sensitive adhesive and the continuous release liner web of backing material through use of a negative pressure applied to the label through at least some of the channels in communication with the vacuum source.

2. The labeling apparatus of claim 1, wherein the vacuum roller further comprises an inner portion and an outer portion, the outer portion rotating relative to the inner portion, the outer portion comprising an outermost sleeve or coating of a resilient, deflectable material.

3. The labeling apparatus of claim 2, wherein the inner portion includes an opening extending therethrough in communication with the vacuum source and a vacuum cavity in communication with the opening, the vacuum cavity extending radially from the opening to a periphery of the inner portion.

4. The labeling apparatus of claim 3, wherein the vacuum cavity is wedge-shaped, increasing in dimension toward the periphery of the inner portion.

5. The labeling apparatus of claim 4, wherein the channels are in communication with the vacuum source only when they are aligned with the vacuum cavity.

6. The labeling apparatus of claim 2, wherein the sleeve or coating is an outermost member of the outer portion and includes a plurality of first openings extending therethrough, the outer portion further including an innermost member including a plurality of second openings, wherein the first openings are aligned with the second openings to form the channels that are in communication with the vacuum source.

7. The labeling apparatus of claim 6 further comprising a conveyor system for moving containers by the vacuum roller, the conveyor system including a plurality of support plates, each support plate sized and configured to carry a container thereon and perform a rotational sequence as the support plates are moved by the conveyor system.

8. The labeling apparatus of claim 7, wherein the vacuum roller is arranged and configured to apply the label to a container, the sleeve or coating being deflected as pressure is applied against the label by the vacuum roller to adhere the label to the container.

9. The labeling apparatus of claim 8, wherein both the vacuum roller and the container rotate as the label is applied to the container by the vacuum roller, the vacuum roller rotating slower than the container.

10. A method of applying a pressure sensitive adhesive label to a container using a labeling apparatus, the method comprising:
providing a continuous release liner web of backing material in roll form, the continuous release liner web of backing material having a plurality of labels adhered thereon at spaced-apart label regions using a pressure sensitive adhesive, the continuous release liner web of backing material configured to allow the labels to be removed therefrom without damaging the labels;
continuously feeding the continuous release liner web of backing material with the labels adhered thereon using a feeding mechanism;
drawing the continuous release liner web of backing material over a peel plate including a peeling edge over which the continuous release liner web of backing material is drawn by the feeding mechanism, the peeling edge of the peel plate having a shape that promotes a leading edge of the labels to loosen from the continuous release liner web of backing material as the corresponding label region is drawn over the peeling edge;
engaging a label at its leading edge with a vacuum roller prior to the leading edge of the label being loosened from the continuous release liner web of backing material by the label region being drawn over the peeling edge of the peel plate; and
releasing the label from the continuous release liner web of backing material as the vacuum roller rotates by overcoming the bond between the pressure sensitive adhesive and the continuous release liner web of backing material through use of a negative pressure applied to the label through channels of the vacuum roller in communication with a vacuum source.

11. The method of claim 10 comprising providing the vacuum roller with an inner portion and an outer portion, the outer portion rotating relative to the inner portion, the outer portion comprising an outermost sleeve or coating of a resilient, deflectable material.

12. The method of claim 11, wherein the inner portion includes an opening extending therethrough communicating with a vacuum source and a vacuum cavity communicating with the opening, the vacuum cavity extending radially from the opening to a periphery of the inner portion.

13. The method of claim 12, wherein the vacuum cavity is wedge-shaped, increasing in dimension toward the periphery of the inner portion.

14. The method of claim 12, wherein the channels are in communication with the vacuum source only when they are aligned with the vacuum cavity.

15. The method of claim 11, wherein the sleeve or coating is an outermost member of the outer portion and includes a plurality of first openings extending therethrough, the outer portion further including an innermost member including a plurality of second openings, the method further comprising aligning the first openings with the second openings to form the channels that are in communication with the vacuum source.

16. The method of claim 15 comprising providing a conveyor system for moving containers past the vacuum roller, the conveyor system including a plurality of support plates, each support plate sized and configured for carrying a container thereon and performing a rotational sequence as the support plates are moved using the conveyor system.

17. The method of claim 16 comprising applying the label to the container using the vacuum roller and deflecting the sleeve as pressure is applied against the label by the vacuum roller to adhere the label to the container.

18. The method of claim 17 comprising rotating both the vacuum roller and the container as the label is applied to the container by the vacuum roller, the vacuum roller rotating slower than the container.

19. A labeling apparatus for continuously labeling containers with printed labels from a continuous roll of backing material, the labeling apparatus comprising:
a feeding mechanism configured to continuously dispense a continuous release liner web of backing material with labels adhered thereon at spaced-apart label regions using a pressure sensitive adhesive, the continuous release liner web of backing material configured to allow the labels to be removed therefrom without damaging the labels;
a peel plate including a peeling edge over which the continuous release liner web of backing material is drawn by the feeding mechanism, the peeling edge of the peel plate having a shape that promotes a leading edge of the labels to loosen from the continuous release liner web of backing material as the corresponding label region is drawn over the peeling edge; and
a vacuum roller including channels extending inwardly from a periphery of the vacuum roller, the channels being in communication with a vacuum source, the vacuum roller being arranged and configured (i) to engage a label at its leading edge prior to a leading edge of the label being loosened from the continuous release liner web of backing material by being drawn over the peeling edge of the peel plate and (ii) to capture the label and direct the label from the continuous release liner web of backing material to a periphery of a container as the vacuum roller rotates by overcoming the bond between the pressure sensitive adhesive and the continuous release liner web of backing material through use of a negative pressure applied to the label through at least some of the channels in communication with the vacuum source.

20. The labeling apparatus of claim 19, wherein the vacuum roller further comprises an inner portion and an outer portion, the outer portion rotating relative to the inner portion, the outer portion comprising an outermost sleeve or coating of a resilient, deflectable material.
